(19) United States
(12) Patent Application Publication
(10) Pub. No.: US 2015/0244095 A1
(43) Pub. Date: Aug. 27, 2015

(54) ELECTRICAL CONNECTOR

(71) Applicant: LOTES CO., LTD, Keelung (TW)

(72) Inventor: Ted Ju, Keelung (TW)

(21) Appl. No.: 14/304,626

(22) Filed: Jun. 13, 2014

(30) Foreign Application Priority Data
Feb. 27, 2014 (CN) 201420085704.9

(51) Int. Cl. H01R 13/26; H01R 12/71; H01R 13/03; H01R 3/08; H01R 13/50

(52) U.S. Cl. CPC H01R 13/26; H01R 3/08; H01R 13/50; H01R 13/03; H01R 12/714

(57) ABSTRACT

An electrical connector for electrically connecting a chip module to a circuit board, includes an insulation body having a plurality of receiving holes. Each receiving hole runs through an upper surface and a lower surface of the insulation body, and is internally and laterally provided with a receiving space. Each receiving hole is internally provided with a conducting assembly. The conducting assembly includes a first conductor correspondingly conductively connected to the chip module and a second conductor correspondingly conductively connected to the circuit board. The first conductor is conductively connected to the second conductor slidably and obliquely. Each receiving space correspondingly receives an elastomer, and the elastomer elastically supports the first conductors. At least one of the first conductor and the second conductor is in a circular shape.

### CROSS-REFERENCE TO RELATED APPLICATION

This non-provisional application claims priority under 35 U.S.C. §119(a) on Patent Application No. 201420085704.9 filed in P.R. China on Feb. 27, 2014, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates to an electrical connector, and particularly to an electrical connector for electrically connecting a first mating electronic element and a second mating electronic element.

### BACKGROUND OF THE INVENTION

In the electronic industry, many electronic elements are connected to each other by using an electrical connector. Currently, an electrical connector generally adopted in the industry includes an insulation seat and an insulation cover cooperatively integrated, and a first terminal, a second terminal and a compression spring assembled in a receiving hole of the insulation seat. The first terminal and the second terminal are separately disposed at two ends of the compression spring, and contact ends thereof are respectively exposed out of the insulation seat and the insulation cover, for signal transmission at two ends connected to the first terminal and the second terminal.

However, this electrical connector needs to be improved. Namely, since the two ends of the compression spring indirectly urge the first terminal and the second terminal, the current transmission fluctuates, thereby affecting signal stability during communication. Additionally, the first terminal and the second terminal are respectively arranged at the two ends of the compression spring, and to enable elastic extension and retraction of the spring, the receiving hole of the insulation seat for receiving the first terminal, the second terminal and the compression spring is generally made large, which makes contact between the first terminal and the second terminal not tight enough, further makes a forward force between contact positions of the first terminal and the second terminal small, and makes the contact impedance large. Moreover, when an acting force of a mating electronic element on the electrical connector is excessively large, the direction of the elastic stretching action is unstable, so that the location on which the first terminal and the second terminal contact deviates, thereby affecting electrical conductive connection between the electrical connector and the mating electronic element, and affecting signal stability during communication.

Therefore, a heretofore unaddressed need exists in the art to address the aforementioned deficiencies and inadequacies.

### SUMMARY OF THE INVENTION

In one aspect, the present invention is directed to an electrical connector that has a low height and a small impedance, so as to improve stability of electrical connection and signal transmission between a chip module and the electrical connector.

In one embodiment, the electrical connector is used for electrically connecting a chip module to a circuit board. The electrical connector includes an insulation body having multiple receiving holes. Each of the receiving holes runs through an upper surface and a lower surface of the insulation body, and is internally and laterally provided with a receiving space. Each receiving hole is internally received with a conducting assembly. Each conducting assembly includes a first conductor correspondingly conductively connected to the chip module and a second conductor correspondingly conductively connected to the circuit board, and the first conductor is conductively connected to the second conductor slidably and obliquely. Each receiving space correspondingly receives an elastomer, and the elastomers elastically support the first conductors. At least one of the first conductor and the second conductor is in a circular shape.

In one embodiment, both the first conductor and the second conductor are in a circular shape.

In one embodiment, the circular shape is a spherical shape or a round sheet shape.

In one embodiment, the receiving space runs through the upper surface and the lower surface of the insulation body.

In one embodiment, the receiving space and the receiving hole are partially isolated.

In one embodiment, a contact surface of the first conductor and the second conductor is disposed with a liquid conductor.

In one embodiment, the liquid conductor is made of gallium or gallium alloy.

In one embodiment, at least one side of the insulation body is provided with a cover, the cover has a through-hole corresponding to each of the receiving holes, and the inner diameter of the through-hole is less than the inner diameter of the receiving hole.

In one embodiment, the first conductor and the second conductor partially protrude from the upper surface and the lower surface of the insulation body.

In another aspect, the present invention is directed to an electrical connector for electrically connecting a first electronic element and a second electronic element. In one embodiment, the electrical connector includes at least one first conductor and at least one second conductor. One end of the first conductor may be electrically connected to the first electronic element, one end of the second conductor may be electrically connected to the second electronic element. A slidable contact surface is arranged between the first conductor and the second conductor. During compression contact, the first conductor and the second conductor may obliquely slide. The at least one conductor is in a circular shape. An elastic insulator urges the first conductor or the second conductor, so as to provide an acting force in a direction opposite to a sliding direction.

In one embodiment, the contact surface is an arc surface.

In one embodiment, a contact surface of the first conductor and the second conductor is provided with gallium or gallium alloy.

In one embodiment, a position on which the first conductor and the first electronic element are conductively connected is provided with gallium or gallium alloy.

In one embodiment, the first conductor and the second conductor are in a circular shape.

In one embodiment, the first conductor and the second conductor are in a spherical shape.

In one embodiment, the elastic insulator is in a spherical shape.

In one embodiment, the elastic insulator is combined with an insulation body through over-injection molding process.

In a further aspect, the present invention is directed to an electrical connector for electrically connecting a first electronic element and a second electronic element. In one embodiment, the electrical connector includes an insulation body having multiple receiving holes, and at least one first conductor and at least one second conductor. One end of the first conductor may be electrically connected to the first electronic element. One end of the second conductor may be electrically connected to the second electronic element. A slidable contact surface is arranged between the first conductor and the second conductor. During compression contact, the first conductor moves downward and obliquely, and the second conductor moves upward and reversely obliquely. At least one elastic insulator urges the first conductor and the second conductor, so as to separately provide the first conductor and the second conductor with acting forces in opposite movement directions, and make the first conductor and the second conductor maintain slidable contact at any time.

In one embodiment, at least one of the conductors is in a circular shape. In one embodiment, the circular shape is a spherical shape or a round sheet shape. In one embodiment, the receiving space runs through the upper surface and the lower surface of the insulation body.

In one embodiment, the receiving space obliquely runs through the insulation body.

In one embodiment, the elastic insulator is provided with a receiving cavity which obliquely runs through the elastic insulator.

In one embodiment, the receiving cavity and the conductor are in interference fit.

In one embodiment, a contact surface of the first conductor and the second conductor is provided with a liquid conductor.

In one embodiment, the liquid conductor is made of gallium or gallium alloy. Compared with the related art, among other things, the present invention has the following beneficial advantages.

By arranging a conductor into a spherical shape, a switching-on path may be shortened, the height and the impedance of the electrical connector may be reduced, and the electric performance may be improved. By arranging the elastomer, the transient interruption phenomenon occurring due to bad contact may be effectively avoided. By arranging the liquid metal conductor between the conductors, the impedance of the electrical connector and occurrence of the transient interruption phenomenon may be further reduced, and the electric performance of the electrical connector may be further improved.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic exploded view of a first embodiment of an electrical connector according to the present invention.

FIG. 2 is a schematic diagram where a chip module is not pressed downward in the first embodiment of the electrical connector according to the present invention.

FIG. 3 is a schematic diagram where a chip module is pressed downward in the first embodiment of the electrical connector according to the present invention.

FIG. 4 is a schematic exploded view of a second embodiment of the electrical connector according to the present invention.

FIG. 5 is a schematic diagram where a chip module is not pressed downward in the second embodiment of the electrical connector according to the present invention.

FIG. 6 is a schematic diagram where a chip module is pressed downward in the second embodiment of the electrical connector according to the present invention.

FIG. 7 is a schematic exploded view of a third embodiment of the electrical connector according to the present invention.

FIG. 8 is a schematic diagram where a chip module is not pressed downward in the third embodiment of the electrical connector according to the present invention.

FIG. 9 is a schematic diagram where a chip module is pressed downward in the third embodiment of the electrical connector according to the present invention.

FIG. 10 is a schematic exploded view of a fourth embodiment of the electrical connector according to the present invention.

FIG. 11 is a schematic assembly view of a fourth embodiment of the electrical connector according to the present invention.

FIG. 12 is a schematic exploded view of a fifth embodiment of the electrical connector according to the present invention.

FIG. 13 is a schematic assembly view of a fifth embodiment of the electrical connector according to the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

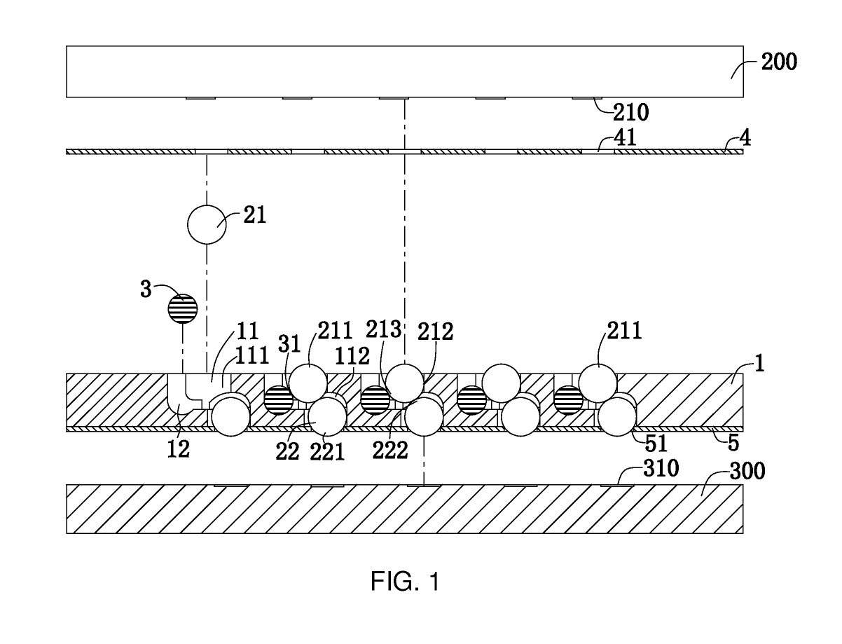

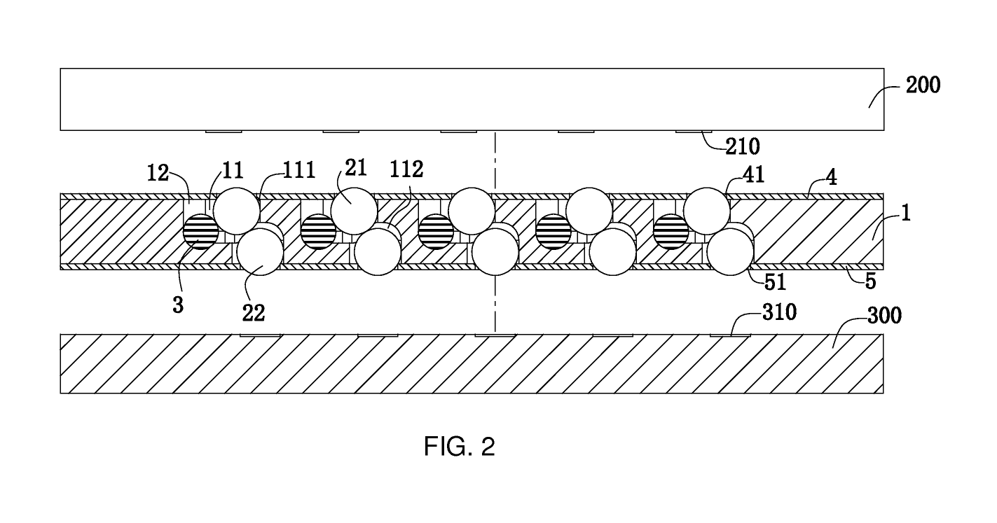

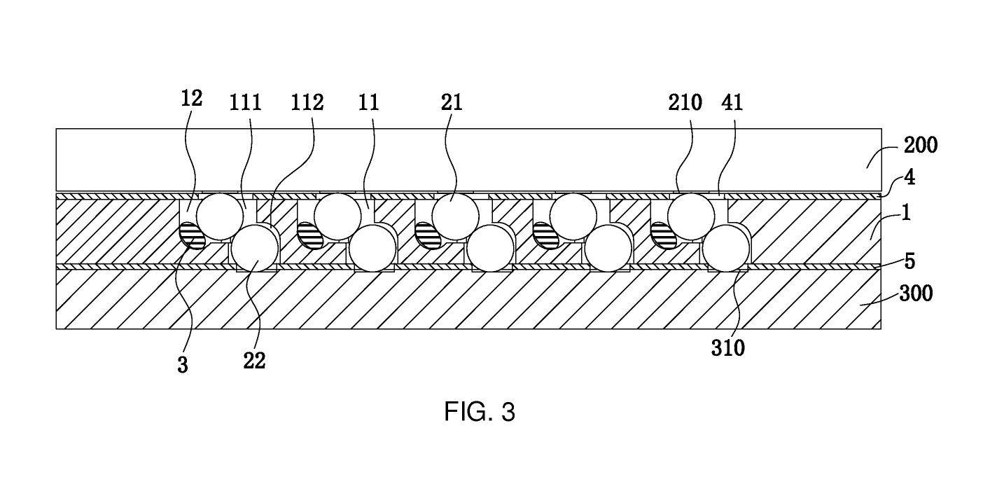

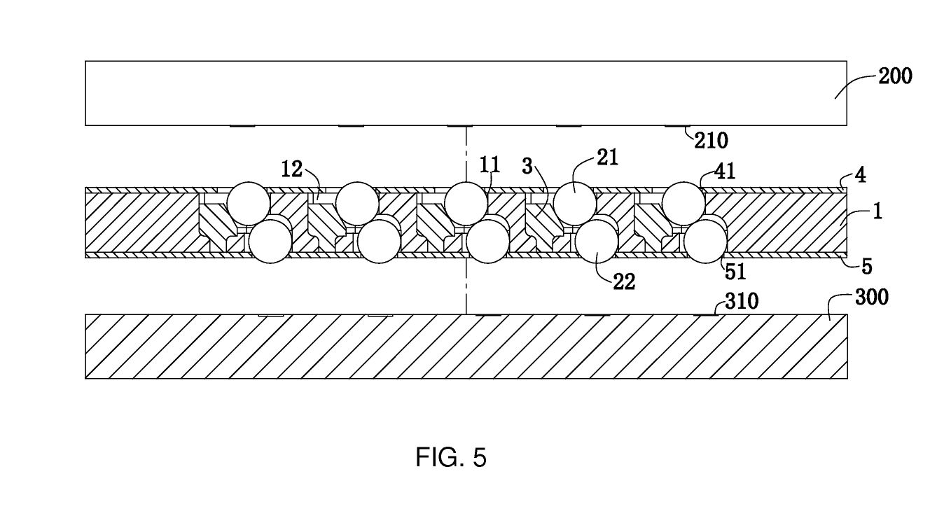

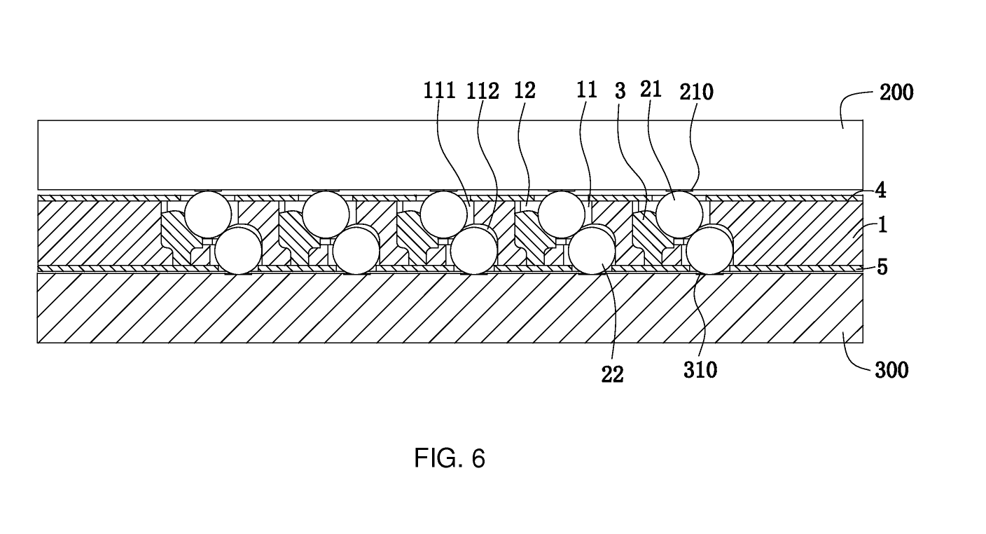

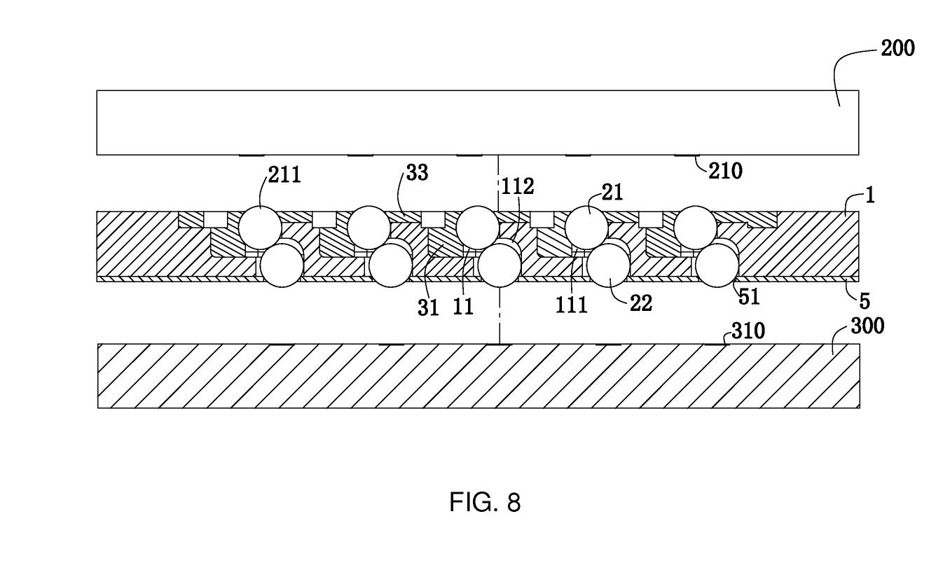

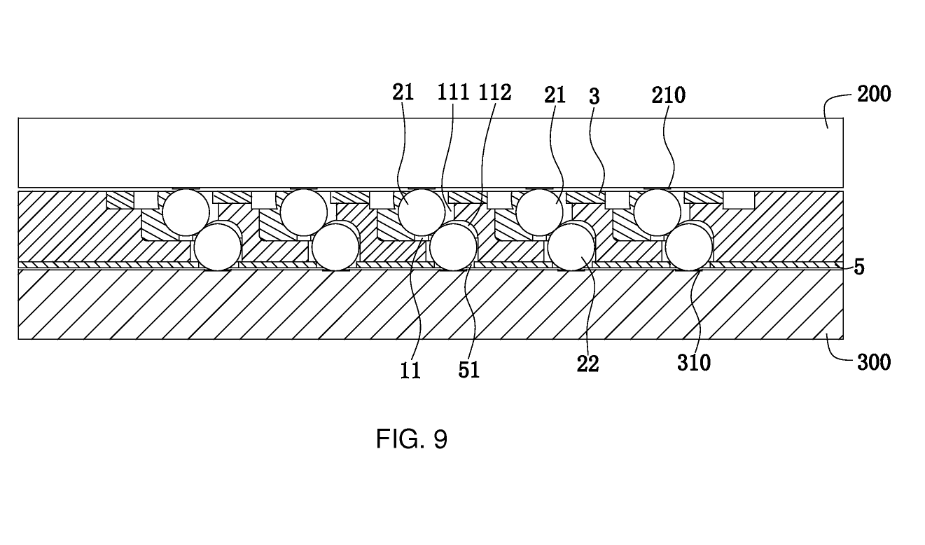

The description will be made as to the embodiments of the present invention in conjunction with the accompanying drawings in FIGS. 1-13. In accordance with the purposes of this invention, as embodied and broadly described herein, this invention, in one aspect, relates to an electrical connector.

As shown in FIG. 1 to FIG. 3, as a first embodiment of an electrical connector of the present invention, the electrical connector is used for electrically connecting a chip module 200 and a circuit board 300. The chip module 200 has multiple first conductive connection portions 210, the first conductive connection portion 210 may be a tin ball or copper gasket. The circuit board 300 has multiple second conductive connection portions 310. The electrical connector includes an insulation body 1, multiple conducting assembly and multiple elastomers 3. Each of the conducting assembly includes a first conductor 21 and a second conductor 22. The conducting assembly and the elastomers 3 are received in the insulation body 1.

The insulation body 1 is in a plate shape, and is made of plastic that is not easily deformed. The insulation body 1 includes receiving holes 11 for receiving the conducting assembly. The receiving hole 11 runs through an upper surface and a lower surface of the insulation body 1, and has a first receiving cavity 111 and a second receiving cavity 112 in oblique communication. The insulation body 1 is laterally and concavely provided with a receiving space 12 in each of the receiving holes 11, that is to say, the insulation body 1 is at least internally provided with the receiving space 12 in lateral communication with the receiving hole 11.

The conducting assembly includes the first conductor 21 and the second conductor 22. Both the first conductor 21 and the second conductor 22 are in a spherical shape. The first conductor 21 and the second conductor 22 may also be presented in a round sheet shape. The first conductor 21 and the second conductor 22 are respectively received in the first receiving cavity 111 and the second receiving cavity 112, and the first conductor 21 is conductively connected to the second conductor 22 slidably and obliquely. The first conductor 21 includes a first contact portion 211, a first mating portion 212 and a first urging portion 213. The second conductor 22 includes a second contact portion 221 and a second mating portion 222. The first contact portion 211 may be electrically connected to the first conductive connection portion 210, and the second contact portion 221 may be electrically connected to the second conductive connection portion 310. The first mating portion 212 and the second mating portion 222 may be conductively connected slidably and obliquely, and a contact area thereof is provided with a liquid metal conductor (not shown). The liquid metal conductor (not shown) is made of a material selected from gallium or gallium alloy, where the gallium alloy is gallium-tin alloy or gallium-indium alloy or gallium-indium-tin alloy. The melting point of gallium is about 29.76° C., so gallium metal may be used directly as the liquid metal conductor (not shown). The melting point of indium is about 156.61° C., the melting point of tin is about 231.93° C., but the melting point of binary or ternary alloy of indium, gallium, and tin may be greatly reduced, and the melting point of the foregoing alloy differs according to different proportions. For example, when the indium-gallium proportion is 24.5:75.5, the melting point of binary alloy of indium and gallium is 15.7° C. When the indium-gallium-tin proportion is 20.5:66.5:13.0, the melting point of ternary alloy of indium, gallium and tin is 10.7° C. Thus, the liquid metal conductor (not shown) may further be any one of indium-gallium, gallium-tin, and indium-gallium-tin. A user may prepare alloy by use of gallium metal, or by use of indium, gallium, and tin metal according to a proportion, so that at the normal temperature, the gallium metal or the gallium alloy is liquid. Therefore, the contact area between conductors is large, the impedance is small, and during current transmission, energy is consumed not due to the impedance, thereby ensuring stability of the current transmission, and good electrical connection effect. The elastomer 3 is in a spherical shape, and includes an elastic portion 31.

When the first conductor 21 is connected to the chip module 200, under the pressure applied downward by the chip module 200, the first conductor 21 downwardly and laterally moves at the same time, and is conductively connected to the second conductor 22 slidably and obliquely. Moreover, the first conductor 21 is extruded to partially enter the receiving space 12, and presses the first elastic portion 31, and the first elastic portion 31 shrinks and provides the first conductor 21 with an oblique urging force F1. The oblique urging force F1 enables the first mating portion 212 of the first conductor 21 to always have an oblique pressure on the second mating portion 222 of the second conductor 22, thereby reducing the contact impedance of two conductive connection surfaces, and ensuring good contact between the first mating portion 212 of the first conductor 21 and the second mating portion 222 of the second conductor 22.

The upper surface and the lower surface of the insulation body 1 are provided with a first cover plate 4 and a second cover plate 5 respectively. The first cover plate 4 has first apertures 41 corresponding to the receiving hole 11, the second cover plate 5 has second apertures 51 corresponding to the receiving hole 11, and the size of the first aperture 41 and the second aperture 51 is less than the size of the first conductor 21 and the second conductor 22, and can prevent the first conductor 21 and the second conductor 22 from escaping from the receiving hole 11.

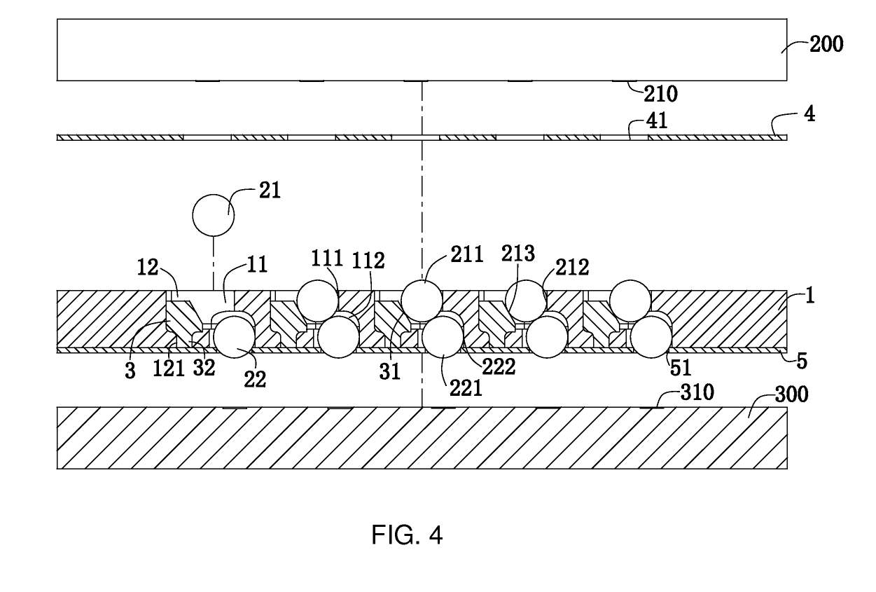

As shown in FIG. 4 to FIG. 6, as a second embodiment of the present invention, this electrical connector and the electrical connector of the first embodiment are different in that, the receiving space 12 runs through the upper surface and the lower surface of the insulation body 1, an installation hole 121 is formed on the insulation body 1, the elastomer 3 includes an elastic portion 31 and an installation portion 32, the elastic portion 31 is a supporting chamfer, the supporting chamfer may elastically urge the first conductor 21, and the installation portion 32 and the installation hole 121 match with each other. This embodiment may also achieve the objective and the technical effect of the first embodiment, which are not described herein anymore.

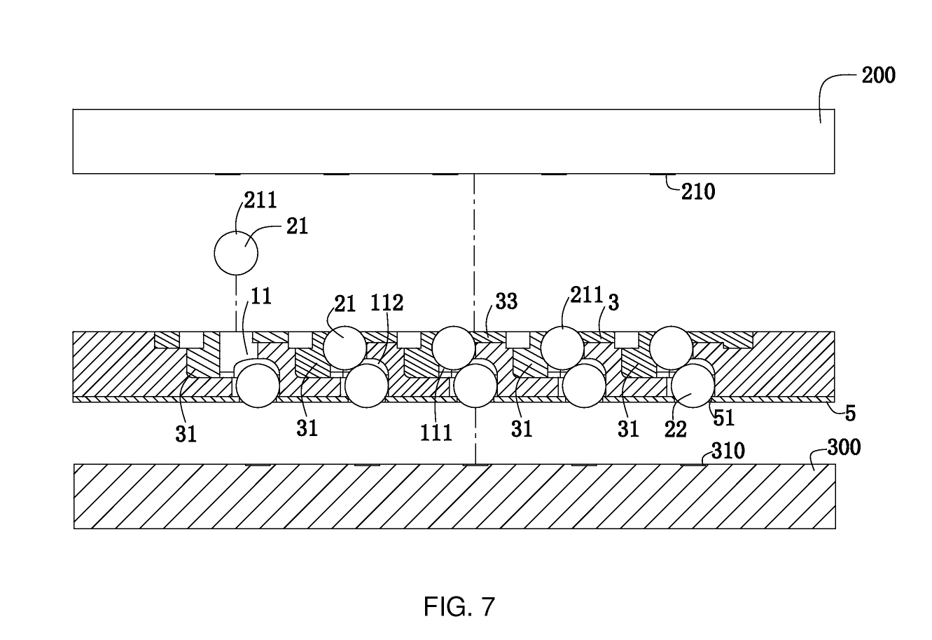

As shown in FIG. 7 to FIG. 9, as a third embodiment of the present invention, this electrical connector and the electrical connector of the first embodiment are different in that, the elastomer 3 is combined with the insulation body 1 through over-injection molding process. The elastomer 3 includes a base portion 33 and multiple elastic portions 31 formed through extension from the base portion 33. The base portion 33 is provided with apertures corresponding to the receiving hole 11. The size of the apertures is less than the size of the first conductor 21, and the first contact portion 211 of the first conductor 21 may be exposed out of the surface of the base portion 33 and electrically conductively connected to the chip module 200. This embodiment may also achieve the objective and the technical effect of the first embodiment, which are not described herein anymore.

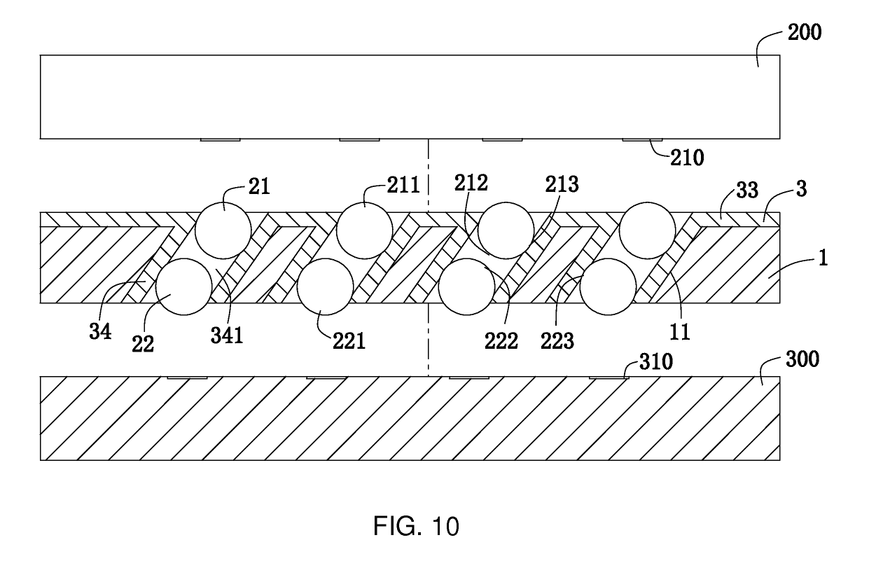

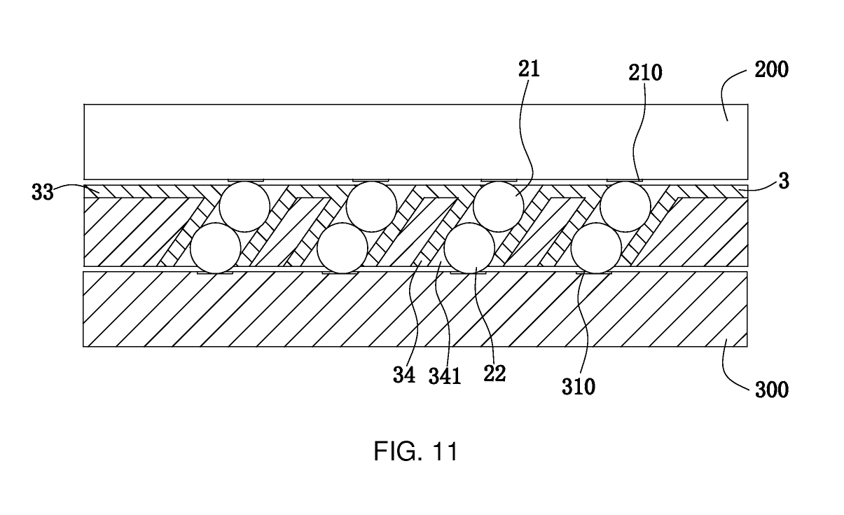

As shown in FIG. 10 and FIG. 11, as a fourth embodiment of the electrical connector of the present invention, the electrical connector is used for electrically connecting a chip module 200 and a circuit board 300. The chip module 200 has multiple first conductive connection portions 210. The first conductive connection portion 210 may be a tin ball or copper gasket. The circuit board 300 has multiple second conductive connection portions 310. The electrical connector includes an insulation body 1, multiple conducting assemblies, and an elastomer 3. Each of the conducting assembly includes a first conductor 21, a second conductor 22, and a liquid metal conductor (not shown). The conducting assembly and the elastomer 3 are received in the insulation body 1.

The insulation body 1 is in a plate shape, and is made of plastic which is not easily deformed. The insulation body 1 has receiving holes 11 for receiving the conducting assembly. The receiving hole 11 runs through an upper surface and a lower surface of the insulation body 1. The receiving hole 11 is obliquely arranged. The surface of the insulation body 1 is provided with multiple protrusions (not shown).

The conducting assembly includes the first conductor 21, the second conductor 22, and the liquid metal conductor (not shown). Both the first conductor 21 and the second conductor 22 are in a spherical shape, and the first conductor 21 and the second conductor 22 may also be in a round sheet shape. The first conductor 21 includes a first contact portion 211, a first mating portion 212, and a first urging portion 213. The second conductor 22 includes a second contact portion 221, a second mating portion 222, and a second urging portion 223. The first contact portion 211 may be electrically connected to the first conductive connection portion 210, and the second contact portion 221 may be electrically connected to the second conductive connection portion 310. The first mating portion 212 and the second mating portion 222 may be conductively connected slidably and obliquely, a contact area thereof is provided with the liquid metal conductor (not shown), and the liquid metal conductor (not shown) is made of a material selected from gallium or gallium alloy.

The elastomer 3 includes a base portion 33 and multiple protruding blocks 34 formed through extension from the surface of the base portion 33. Each of the protruding blocks 34 is provided with a receiving cavity 341. The receiving cavity 341 may be used for receiving the conducting assembly. The protruding block 34 is in an oblique column shape, and the protruding block 34 may be correspondingly received in the receiving hole 11. The base portion 33 has multiple through-holes (not shown) corresponding to the protrusion (not shown), and the height of the base portion 33 is slightly greater than the height of the protrusion (not shown). Both the first conductor 21 and the second conductor 22 are received in the receiving cavity 341, and the size of the receiving cavity 341 is less than the size of the first conductor 21 and the second conductor 22, so the elastomer 3 may elastically clamp the first conductor 21 and the second conductor 22.

The chip module 200 is electrically connected to the circuit board 300 by using the first conductor 21 and the second conductor 22 which are arranged in the elastomer 3 and conductively connected to each other.

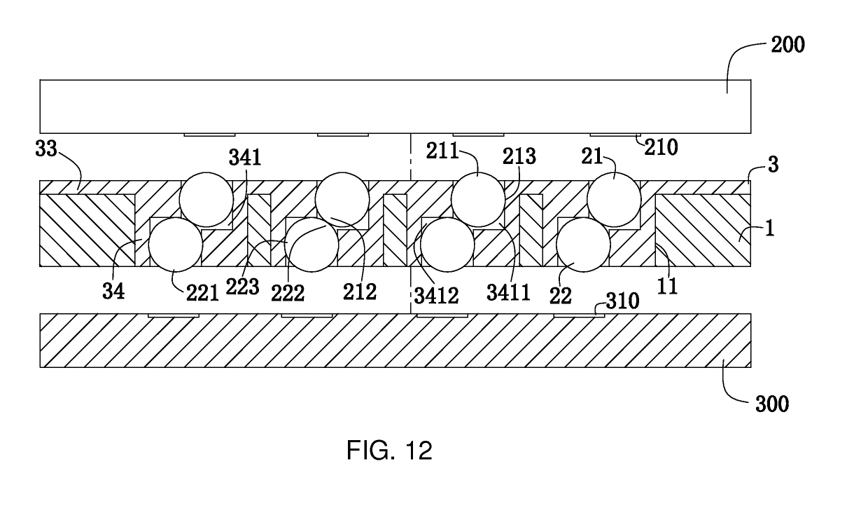

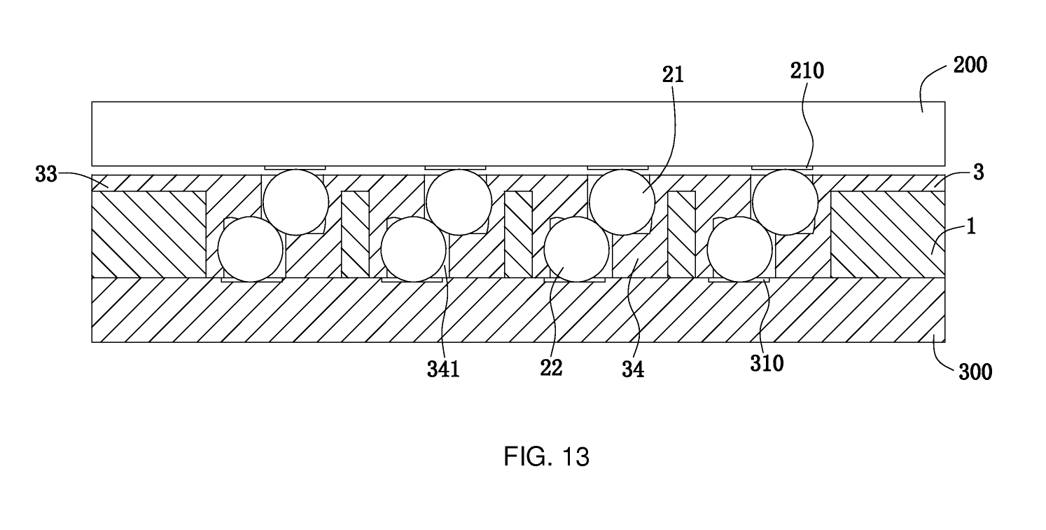

As shown in FIG. 12 and FIG. 13, as a fifth embodiment of the present invention, this electrical connector and the electrical connector of the fourth embodiment are different in that, the elastomer 3 includes a base portion 33 and multiple protruding blocks 34 formed through extension from the surface of the base portion 33. Each of the protruding blocks 34 is provided with a receiving cavity 341. The receiving cavity 341 includes a first receiving hole 3411 and a second receiving hole 3412 in staggered communication. The first conductor 21 and the second conductor 22 which are staggered and conductively connected are respectively assembled in the first receiving hole 3411 and the second receiving hole 3412. This embodiment may also achieve the objective and the technical effect of the fourth embodiment, which are not described herein anymore.

In summary, the electrical connector according to certain embodiments of the present invention, have the following beneficial advantages.

(1) By arranging a conductor into a spherical shape, a switching-on path may be shortened, the height and the impedance of the electrical connector may be reduced, and the electric performance may be improved.

(2) By arranging the elastomer, the transient interruption phenomenon occurring due to bad contact may be effectively avoided.

(3) By arranging the liquid metal conductor between the conductors, the impedance of the electrical connector and occurrence of the transient interruption phenomenon may be further reduced, and the electric performance of the electrical connector may be further improved.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector for electrically connecting a chip module to a circuit board, comprising:
an insulation body having a plurality of receiving holes,
wherein each receiving hole runs through an upper surface and a lower surface of the insulation body, and is internally and laterally provided with a receiving space;
wherein each receiving hole is internally provided with a conducting assembly, the conducting assembly comprises a first conductor correspondingly conductively connected to the chip module and a second conductor correspondingly conductively connected to the circuit board, the first conductor is conductively connected to the second conductor slidably and obliquely;
wherein each receiving space correspondingly receives an elastomer, and the elastomer elastically supports the first conductors; and
wherein at least one of the first conductor and the second conductor is in a circular shape.

2. The electrical connector according to claim 1, wherein both the first conductor and the second conductor are in a circular shape.

3. The electrical connector according to claim 1, wherein the circular shape is a spherical shape or a round sheet shape.

4. The electrical connector according to claim 1, wherein the receiving space runs through the upper surface and the lower surface of the insulation body.

5. The electrical connector according to claim 4, wherein the receiving space and the receiving hole are partially isolated.

6. The electrical connector according to claim 1, wherein a contact surface of the first conductor and the second conductor is provided with a liquid conductor.

7. The electrical connector according to claim 6, wherein the liquid conductor is made of gallium or gallium alloy.

8. The electrical connector according to claim 1, further comprising a cover disposed at one side of the insulation body, wherein the cover has through-holes corresponding to the receiving holes, and the inner diameter of the through-hole is less than the inner diameter of the receiving hole.

9. The electrical connector according to claim 1, wherein the first conductor and the second conductor partially protrude from the upper surface and the lower surface of the insulation body respectively.

10. An electrical connector for electrically connecting a first electronic element and a second electronic element, comprising
at least one first conductor and at least one second conductor,
wherein one end of the first conductor is electrically connected to the first electronic element, one end of the second conductor is electrically connected to the second electronic element, a slidable contact surface is arranged between the first conductor and the second conductor, and during compression contact, the first conductor and the second conductor obliquely slide in a sliding direction;
wherein at least one of the first conductor and the second conductor is in a circular shape; and
wherein an elastic insulator urges the first conductor or the second conductor, so as to provide an acting force in a direction opposite to the sliding direction.

11. The electrical connector according to claim 10, wherein the contact surface is an arc surface.

12. The electrical connector according to claim 10, wherein a contact surface of the first conductor and the second conductor is provided with gallium or gallium alloy.

13. The electrical connector according to claim 10, wherein a position on which the first conductor and the first electronic element are conductively connected is provided with gallium or gallium alloy.

14. The electrical connector according to claim 10, wherein the first conductor and the second conductor are in a circular shape.

15. The electrical connector according to claim 10, wherein the first conductor and the second conductor are in a spherical shape.

16. The electrical connector according to claim 10, wherein the elastic insulator is in a spherical shape.

17. The electrical connector according to claim 10, wherein the elastic insulator is combined with an insulation body through over-injection molding process.

18. An electrical connector for electrically connecting a first electronic element and a second electronic element, comprising:
an insulation body having a plurality of receiving holes;
at least one first conductor; and
at least one second conductor,
wherein one end of the first conductor is be electrically connected to the first electronic element, one end of the second conductor is electrically connected to the second electronic element, a slidable contact surface is arranged between the first conductor and the second conductor, and during compression contact, the first conductor moves downward and obliquely, and the second conductor moves upward and reversely obliquely;
wherein at least one elastic insulator urges the first conductor and the second conductor, so as to respectively provide the first conductor and the second conductor with acting forces in opposite movement directions, and make the first conductor and the second conductor maintain slidable contact at any time.

19. The electrical connector according to claim 18, wherein at least one of the first and second conductors is in a circular shape.

20. The electrical connector according to claim 19, wherein the circular shape is a spherical shape or a round sheet shape.

21. The electrical connector according to claim 18, wherein the receiving space runs through an upper surface and a lower surface of the insulation body.

22. The electrical connector according to claim 21, wherein the receiving space obliquely runs through the insulation body.

23. The electrical connector according to claim 18, wherein the elastic insulator is provided with a receiving cavity which obliquely runs through the elastic insulator.

24. The electrical connector according to claim 18, wherein the receiving cavity and the conductor are in interference fit.

25. The electrical connector according to claim 18, wherein a contact surface of the first conductor and the second conductor is provided with a liquid conductor.

26. The electrical connector according to claim 25, wherein the liquid conductor is made of gallium or gallium alloy.
